(19) United States
(12) Patent Application Publication
(10) Pub. No.: US 2007/0130787 A1
(43) Pub. Date: Jun. 14, 2007

(54) Veneer dryer

(76) Inventors: Wilfried Möller, Friedewald (DE); Gottfried Roos, Hauneck (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/576,504

(22) PCT Filed: Aug. 11, 2004
(86) PCT No.: PCT/EP04/08968

§ 371 Date: Apr. 18, 2006

(30) Foreign Application Priority Data
Oct. 21, 2003 (DE) 103 49 401.4

(51) Int. Cl. D06F 58/00; F26B 25/00; F26B 3/00

(52) U.S. Cl. 34/116; 34/443; 34/236

(57) ABSTRACT

The problem with known veneer dryers is that the individual drying zones cannot be separated distinctly. The optimal process conditions, which change during the drying process, cannot therefore be adjusted as required, as this leads to short-circuit currents between the drying zones. The aim of the invention is to provide a veneer dryer, in which the drying parameters can be optimally adjusted zone by zone. To achieve this, the drying zones (2, 3, 4) are arranged one above the other on horizontal planes and are thus effectively separated from one another. The inventive dryer is used for the production of veneers.

The invention regards a dryer for veneers according to the preamble of claim 1.

Veneers tend to be deformed during the drying process because of different shrinking degrees. This results in wavy veneers that might have cracks and/or pressure marks. In order to avoid such defects, the veneers have to be dried in several drying zones arranged in series with respectively optimally adjusted parameters, such as temperature, moisture of the drying medium, and effective pressure on the veneers. Furthermore the pressure effective on the veneers has to be varied in such way that the wet veneers are initially only exposed to low pressure and the predried veneers are flattened with the help of pressure. Therefore a rectilinear path of conveyor belts is followed by a so-called smoothing section, in which the veneers are deflected many times and are therefore exposed to higher pressure.

From EP 192 207 a dryer for veneers is known that dries the veneers between two conveyor belts initially in a section with rectilinear path and subsequently in a section with a looped path of the conveyor belts. The dryer is divided into fields that can, individually or several of them combined, form drying zones under the necessary drying climate. The fields are arranged in a series in one horizontal plane.

U.S. Pat. No. 6,108,942 describes a dryer for veneers with the path of two conveyor belts forming a rectilinear and a curvilinear drying path, each path being arranged in several horizontal planes that are traversed one after the other. Drying zones can be arranged in series in a horizontal plane.

The known dryers for veneers have the disadvantage that the individual drying zones cannot be distinctly separated. This lack of separation is particularly critical if exhaust air from e.g. a first drying zone is introduced into a second one. This way, a backflow of drying medium from the second into first drying zone, consequently a mixing of the drying parameters, is always observed. As shown in practice, the differences of temperature between the individual drying zones can be kept on a level of maximal 30° C., the desired moisture of the drying medium and the veneers in the single zones of the dryer can only be regulated in a correspondingly inexact way. This leads to a reduced quality of the veneers that have e.g. pressure marks caused by the belts, cracks and/or are wavy imperfections.

Deflection or deflecting in the following refers to guiding of the conveyor belts after deflection such that the general direction of conveyance, thus without consideration of a looped and/or wavy path, coming from one end of the dryer changes about 180°, returning to the same end. Thereby the planes of conveyance are parallel or almost parallel.

It is the object of the invention to provide a dryer for veneers able to produce veneers of optimum quality due to the fact that the drying parameters in the drying zones can be selectively set to a large extent.

The object is achieved by means of the characterizing features of claim 1. With the arrangement of the drying zones one above the other in horizontal planes a transfer of important quantities of the drying medium from one drying zone into an adjacent drying zone can be avoided without further efforts as far as sealing is concerned. This has the effect that, dependant on the wood type, in every individual drying zone a perfect drying climate can be adjusted in an aimed manner without thereby influencing the adjacent drying zones. The conveyor belts thereby are deflected at least when passing from one drying zone into the next one, so that the general direction of conveyance is changed on movement from one into the next drying zone.

With the same length of the drying path, the conveyor belts are all in all shorter than if the drying zones were situated in the same plane, since the feedback to the dryer intake occurs via a significantly shorter path.

It is a further advantage that due to the arrangement of the drying zones one above the other space is saved for the placement of the dryer.

The dependent claims relate to the advantageous design of the invention.

The separation in space of the deflecting rollers, arranged in the passage from one drying zone to the next one, from the drying zones according to claim 2 allows an even better compartmentalization of the drying zones and a simpler construction of the deflecting means.

The additional deflection of the conveyor belts in one of the drying zones according to claim 3 extends the path in this drying zone with comparatively little effort and thus improves the performance of the dryer.

The extension of the rectilinear path of the conveyor belts into at least one part of the second drying zone according to claim 4 has as the result that a first deflection of the conveyor belts and thereby a higher pressure on the veneers is only carried out when the surfaces of the veneers are already almost dry. Thus it can be safely avoided that the pattern of the conveyor belts is pressed into the surfaces and is thus visible.

The division of the conveyor belt according to claim 5 enables a decoupling of the pressure effected on the veneers by the conveyor belts in the smoothing section and the pressure in the remaining part of the dryer. Thus the pressure can be optimally adjusted in the smoothing section.

The drying zones according to claim 6 permit a perfect adaptation of the drying conditions to the demands.

If the conveyor belts are supported in the rectilinear path as claimed in claim 7, the tension of the conveyor belts may be low without them unduly drooping. The pressure on the veneers is thus further reduced in this section.

A sensor according to claim 8 in combination with an analyzing and regulating system allows a perfect adaptation of the drying process to different qualities of the veneers.

Radial fans according to claim 9 permit a particularly compact construction of the dryer.

Means leading the exhaust air from one of the drying zones into a different one according to claim 11 allow an easy humidification of the drying medium in the drying zone into which the exhaust air is introduced. A higher material temperature can be set that ensures a safe plastifying of the lignin bonds in the veneers and therefore leads to elastic veneers.

The invention is further described in the drawing with the help of a schematic example. Therein:

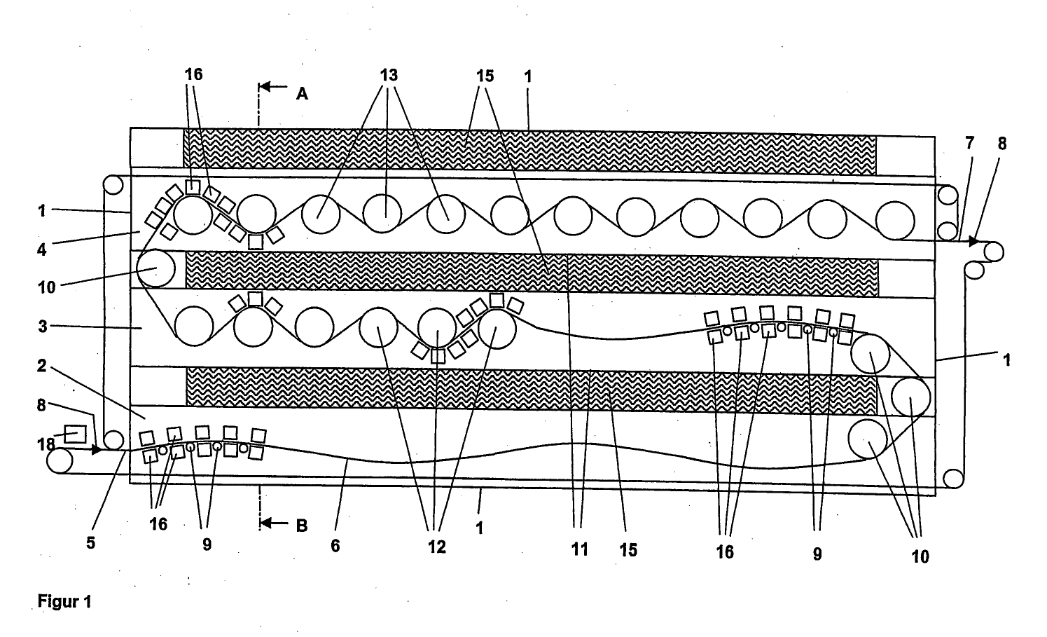

FIG. 1 is a longitudinal section of a dryer;

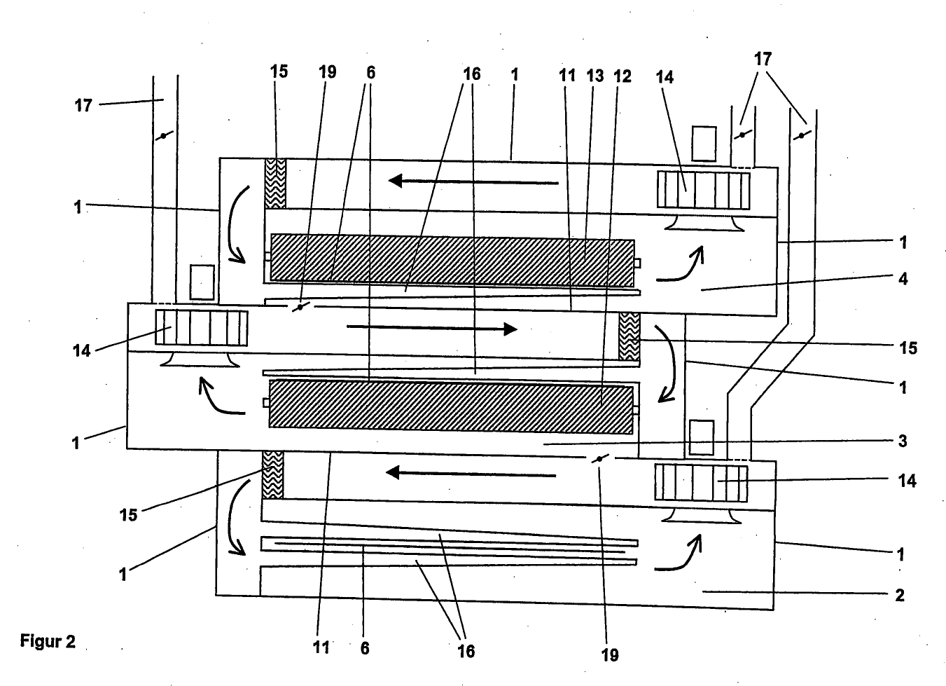

FIG. 2 is a sectional view of a dryer along the line A-B; and

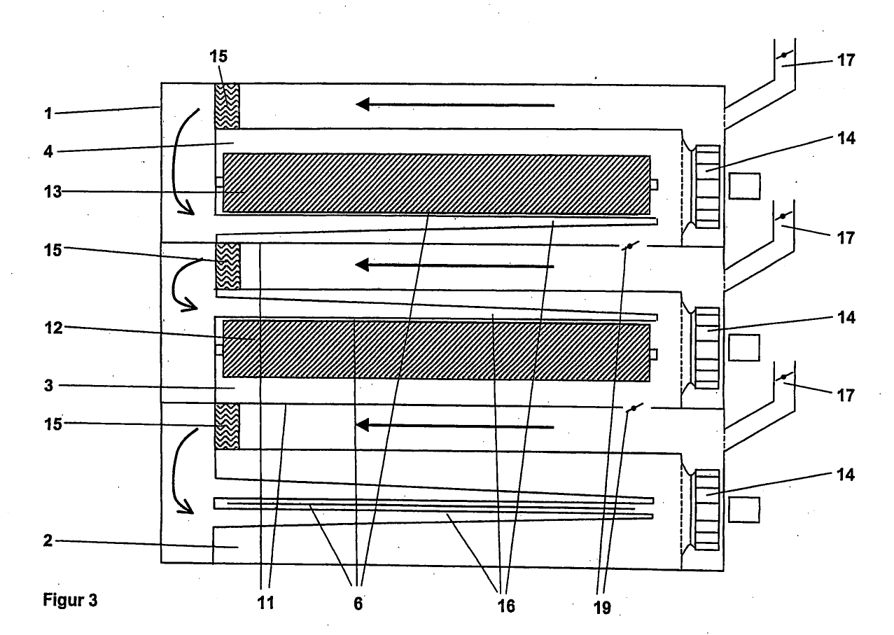

FIG. 3 is a cross-sectional view of a dryer of another embodiment.

As demonstrated by the figures a housing 1 surrounds a drying area comprising three drying zones 2, 3, 4. The drying zones 2, 3, 4 are arranged in horizontal planes one above the other and separated by floors 11. From a dryer intake 5 that is arranged in the left bottom according to FIG. 1, two endless conveyor belts 6 are arranged parallel and in short distance to each other or arranged in series tangent to each other guided through the drying zones 2, 3, 4 to a dryer output 7, arranged at a side of the drying area opposing the dryer intake 5. The transport direction is illustrated by arrows 8. At the dryer intake 5 the lower conveyor belt 6 is guided such that it protrudes from the dryer for a short distance. The conveyor belts 6 are provided with a regulatable driving system and are guided back from the dryer output 7, individually passing rolls and a tension device to the dryer intake 5.

In the first drying zone 2 and in the first half of the second (seen in transport direction) drying zone 3 the conveyor belts 6 form small waves, thus are guided almost in a straight line in one plane. Hence supporting rollers 9 are spaced in the transport direction, only part of which is illustrated. The longitudinal axes of the supporting rollers 9 are aligned horizontally as well as perpendicularly to the transport direction. The conveyor belts 6 are guided over the supporting rollers 9. At the end of the first drying zone 2, the conveyor belts 6 are deflected over the three deflecting rollers 10 in such a way to the second drying zone 3 that the general transport direction is changed by 180°. Here the lowermost part of the lower deflecting roller 10 and the uppermost part of the upper deflecting roller 10 are on a generally central level of the corresponding drying zone 2, 3.

In the second half of the second drying zone 3 the smoothing section starts. To this end a plurality of rollers 12 spaced in a horizontal plane is arranged, wherein their longitudinal axes are orthogonal to the transport direction. The axial distance between two of the rollers 12 approximately corresponds to three times the radius of one of the rollers 12. The conveyor belts 6 are alternatingly guided on a looped path above and below the rollers 12. At the end of the second drying level 3 the conveyor belts 6 of the last roller 12 are guided under a further deflecting roller 10 to a first of a plurality of rollers 13 of the third drying level 4 and thus deflected by 180°.

The rollers 13 of the third drying level 4 are arranged in a horizontal plane, their longitudinal axes being orthogonal to the transport direction. The rollers 13 have the same diameter as the rollers 12 of the second drying level 3. The axial distance between the rollers 13 is about three times their radiuses. The looped path of the conveyor belts 6 is continued in the third drying zone 4.

Each drying zone 2, 3, 4 has associated means for blowing drying medium against the veneers. Usually air is used as the drying medium and is recirculated. The means for blowing the air comprise for each drying zone 2, 3, 4 at least one fan, in this case a radial fan 14 with regulatable drive, at least one heat exchanger 15 with regulatable feeding of heating means, a plurality of nozzle boxes 16 in known arrangement, only part of which is illustrated in FIG. 1, an exhaust air conduct 17 with regulating damper, as well as different channels for gathering and distributing drying medium. The radial fan 14 is fixed to a horizontal part of the housing 1 by means of a perpendicular driving axle.

In one section in front of the dryer intake 5 a sensor 18 for the determination of the moisture of the undried veneers is arranged. The sensor 18 is connected to a corresponding analyzing unit.

Part of a drying device for veneers in addition to the dryer are further not illustrated devices, like a feeding device that passes the veneers to the lower conveyor belt 6 at the hand-over-point, a cooler for the veneers and an output device.

In contrast to the example described it is possible to provide only two temperature zones 2, 3. Thereby the smoothing section is always located in the second drying zone 3, while the rectilinear part of the conveyor belts 6 is arranged in the first drying zone 2 and if necessary in a part of the second drying zone 3.

The conveyor belts 6 can be deflected by 1800 in one or more drying zones 2, 3, 4, in order to extend the travel path and thereby the residence time of the veneers in the corresponding drying zones 2, 3, 4. The deflection of the conveyor belts 6 into the next drying zone 3, 4 or the delivery of the veneers takes place at the same side of the drying area as the input in the corresponding drying zone 2, 3, 4.

Furthermore each deflection of the conveyor belts 6 from a drying zone 2, 3 to the next can be set outside the corresponding drying zones 2, 3, 4. This way their deflections are separated from the drying zones 2, 3, 4, e.g. by means of sheet metals.

In one embodiment of the invention the conveyor belt 6, arranged on the upper side in the smoothing section, is divided in two. That means that the upper conveyor belt 6 ends after the beginning of the drying zone 4, the third according to FIG. 1 and a new upper conveyor belt starts immediately afterward. Thereby the in the smoothing section upper conveyor belt 6 is configured in such way that it here exerts higher pressure on the veneers than in the remaining part of the dryer. This can be achieved by a higher tension and/or an especially high mass per unit area of the conveyor belt 6.

A further embodiment, illustrated in FIG. 3 is distinguished by the following characteristics from the example according to FIGS. 1 and 2: the radial fans 14 have a horizontal rotation axis and are all arranged at one side of the housing 1 only. Thereby the housing 1 can be cuboid shaped for the whole dryer, without recesses and/or salients.

In the operating process the veneers that are cut in a thickness of e.g. 0.2 to 4.0 mm in the form of sheets from a block of wood are passed on to in this position lower conveyor belt 6, by the feeding device shortly before the dryer intake 5. Thereby the veneers are mostly lying in flat position on the conveyor belt 6. Before the conveyor belt 6 conveys the veneers to the dryer, their moisture, consequently the quantity of water per quantity of dry wood is measured. As soon as the veneers enter the dryer, they are covered by the upper conveyor belt 6 and are pressed flatly to the lower conveyor belt 6 due to its tare weight.

In each drying zone 2, 3, 4 the associated ventilators 14 draw the drying air from the corresponding drying zone 2, 3, 4 and force it through the associated channels for distribution and through the heat exchangers 15 into the nozzle boxes 16 that direct the air through the conveyor belts 6 to the veneers. This way, the drying air for every drying zone 2, 3, 4 is recirculated, as indicated with arrows in FIG. 2. A part of the drying air is exhausted before heating in the heat exchangers 15 as exhaust air through the exhaust air conducts 17. Means for venting the exhaust air, that means conducting exhaust air before the heating in the heat exchangers 15 from one of the drying zones 2, 3, 4 to another one, is effected by dampers 19 in the floors 11 into one of the or into the next drying zone(s) 3, 4, in order to increase the (absolute) humidity of the air there and thus enable the setting of higher drying air temperatures.

In the first drying zone 2 the veneers are substantially guided in a straight line, the light wave movement being caused by the support by the supporting rollers 9. This path ensures that the veneers are only exposed to low pressure that does not damage their surfaces. Temperature and moisture of the drying air are regulated such that the surfaces of the veneers are dried to a large extent. This way discolorations and the so-called shrinking phenomena (shrinking of the surface, hampered by the still moist inner parts, thus causing tensions and cracks in the surface) of the veneers is avoided.

At the end of the first drying zone 2 the veneers are guided upward to the second drying zone 3, the general transport direction being changed by 180°.

In the second drying zone 3 the veneers are at first guided substantially in a straight line and later on a looped path around the rollers 12. Here the veneers pass through a rectilinear path between the rollers 12, the length of which corresponds at least to the diameter of the rollers 12. Temperature and humidity of the drying air are regulated such that the moisture of the veneers at the beginning of the smoothing section, thus in about the middle of the second drying zone 3, is of at least 30%.

At the end of the second drying zone 3 the veneers are guided upward to the third drying zone 4, the transport direction changing again by 180°.

In the third drying zone 4, the smoothing section with the looped path is continued. The temperature and humidity of the drying air are regulated in such way that on the one hand the lignin bonds in the wood are plastified and elastic veneers are formed and on the other hand the desired final moisture of the veneers is attained.

Temperature and air humidity vary from drying zone to drying zone and depend on the type of wood, the initial moisture of the veneers and the quantity of veneers. The speed of the conveyor belts, the rotation rate of the fans, the quantity of heating means as well as the quantity of exhaust air and the guiding means for exhaust air are adequately regulated. Therefore automating means are provided.

After the drying process the veneers are cooled and arranged in piles in the known manner.

1. A dryer for veneers with a conveying device, the veneers being conveyed between two conveyor belts lying one upon the other from a dryer intake to a dryer output, with the conveyor belts running at first in a straight line or almost in a straight line in a transport direction and subsequently running in loops around a plurality of rollers, means being provided for blowing drying medium on the veneers, the dryer comprising at least two drying zones in which different temperatures and/or moistures of the drying medium can be set, characterized in that the drying zones (2, 3, 4) are located in horizontal planes one above the other.

2. The dryer according to claim 1, characterized in that deflecting rollers (10) situated in the passage from one of the drying zones (2, 3) to the next one are physically separated from the drying zones (2, 3, 4).

3. The dryer according to claim 1, characterized in that the conveyor belts (6) are additionally deflected in at least one of the drying zones (2, 3, 4) in order to change the general conveying direction.

4. The dryer according to claim 1, characterized in that the rectilinear or almost rectilinear path of the conveyor belts (6) is extended to the first drying zone (2) and to at least a part of the second drying zone (3).

5. The dryer according to claim 1 characterized in that the conveyor belt (6), situated on the upper side in the last drying zone (4) and exclusively running in loops, is divided into two endless sections arranged in series in conveying direction.

6. The dryer according to claim 1, characterized in that the dryer comprises three drying zones (2, 3, 4).

7. The dryer according to claim 1, characterized in that the conveyor belts (6) are supported in the rectilinear path.

8. The dryer according to claim 1, characterized in that a sensor (18) for the determination of the moisture of the veneers is located in front of or at the dryer intake (5).

9. The dryer according to claim 1, characterized in that the means for blowing on the drying means comprise radial fans (14) with a horizontal rotation axis.

10. The dryer according to claim 1, characterized in that means are disposed for leading drying air (19) from one of the drying zones (2, 3, 4) into at least one other.
